(19) United States
(12) Patent Application Publication
(10) Pub. No.: US 2021/0096341 A1
(43) Pub. Date: Apr. 1, 2021

(54) PROJECTION ZOOM LENS AND PROJECTOR

(71) Applicant: Coretronic Corporation, Hsin-Chu (TW)

(72) Inventors: Wei-Ting Wu, Hsin-Chu (TW); Meng-Feng Chung, Hsin-Chu (TW); Ching-Chuan Wei, Hsin-Chu (TW); Tao-Hung Kuo, Hsin-Chu (TW)

(73) Assignee: Coretronic Corporation, Hsin-Chu (TW)

(21) Appl. No.: 17/023,368

(22) Filed: Sep. 17, 2020

(30) Foreign Application Priority Data
Sep. 29, 2019 (CN) 201910930792.5

(51) Int. Cl. G02B 15/14; G02B 13/18

(52) U.S. Cl. CPC G02B 15/1425; G02B 13/18

(57) ABSTRACT

The invention provides a projection zoom lens and a projector. The projection zoom lens includes a first lens group and a second lens group sequentially arranged along an optical axis from a screen end to an image source end. The first lens group has a negative refractive power and includes a first lens, a second lens, and a third lens. The second lens group has a positive refractive power and includes a fourth lens, a fifth lens, a sixth lens, a seventh lens, an eighth lens, a ninth lens, a tenth lens, an eleventh lens, and a twelfth lens. The first lens to the twelfth lens are sequentially arranged along the optical axis from the screen end to the image source end, and the refractive powers of the first lens to the twelfth lens are negative, negative, positive, positive, positive, negative, negative, positive, positive, negative, positive, and positive.

### CROSS-REFERENCE TO RELATED APPLICATION

This application claims the priority benefit of China application serial no.

201910930792.5, filed on Sep. 29, 2019. The entirety of the above-mentioned patent application is hereby incorporated by reference herein and made a part of this specification.

### BACKGROUND

### 1. Technical Field

The invention relates to a projection lens and a projector using the same, and particularly relates to a projection zoom lens and a projector using the same.

### 2. Description of Related Art

The current trend in the field of zoom lens technology is to develop projection zoom lenses with lower cost, higher resolution, and higher power zoom. In the highly competitive market, manufacturers are working hard to design a suitable lens architecture to reduce the cost, size, and weight while maintaining the zoom and high resolution. In order to meet such requirements, reducing the use of aspherical lenses and reducing the number of lens groups and the number of lenses are all feasible.

In the design of high-resolution projection zoom lenses, aberration is usually reduced by increasing the number of lens groups or aspherical lenses, but such a design will increase the cost and assembly difficulty. Therefore, how to achieve a balance between optical imaging quality, cost, and assembly difficulty is an issue that needs to be addressed.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention provides a projection zoom lens and a projector that achieve a balance between optical imaging quality, cost, and assembly difficulty.

Other objectives and advantages of the invention can be further illustrated by the technical features broadly embodied and described as follows.

In order to achieve one or part or all of the above or other objectives, an embodiment of the invention provides a projection zoom lens, including: a first lens group and a second lens group which are sequentially arranged along an optical axis from a screen end to an image source end. The first lens group has a negative refractive power and includes a first lens, a second lens, and a third lens. The second lens group has a positive refractive power and includes a fourth lens, a fifth lens, a sixth lens, a seventh lens, an eighth lens, a ninth lens, a tenth lens, an eleventh lens, and a twelfth lens. The first lens to the twelfth lens are sequentially arranged along the optical axis from the screen end to the image source end, and the refractive powers of the first lens to the twelfth lens are negative, negative, positive, positive, positive, negative, negative, positive, positive, negative, positive, and positive.

In order to achieve one or part or all of the above or other objectives, an embodiment of the invention provides a projector, including: an image source and a projection zoom lens. The image source provides an image beam. The projection zoom lens is disposed on a transmission path of the image beam to project the image beam onto a screen to form a projection image. The projection zoom lens includes a first lens group and a second lens group which are sequentially arranged along an optical axis from a screen end to an image source end. The screen is located at the screen end. The image source is located at the image source end. The first lens group has a negative refractive power and includes a first lens, a second lens, and a third lens. The second lens group has a positive refractive power and includes a fourth lens, a fifth lens, a sixth lens, a seventh lens, an eighth lens, a ninth lens, a tenth lens, an eleventh lens, and a twelfth lens. The first lens to the twelfth lens and the image source are sequentially arranged along the optical axis from the screen end to the image source end, and the refractive powers of the first lens to the twelfth lens are negative, negative, positive, positive, positive, negative, negative, positive, positive, negative, positive, and positive.

Based on the above, the embodiments of the invention have at least one of the following advantages or effects. In the embodiments of the projection zoom lens and the projector of the invention, the projection zoom lens uses twelve lenses to form two lens groups and realizes the zoom function by adjusting the relative positions of the two lens groups. Therefore, the projection zoom lens and the projector of the invention achieve a balance between optical imaging quality, cost, and assembly difficulty.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 and FIG. 2 are schematic diagrams respectively showing a projector at the wide-end and the tele-end according to an embodiment of the invention.

FIG. 3A and FIG. 3B are modulation transfer function (MTF) graphs of a projector at the wide-end and the tele-end according to an embodiment of the invention.

FIG. 4 to FIG. 6 are a lateral color aberration graph, an astigmatic field curvature graph, and a distortion graph of a projector according to an embodiment of the invention.

FIG. 7A to FIG. 7H are ray fan plots of a projector according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

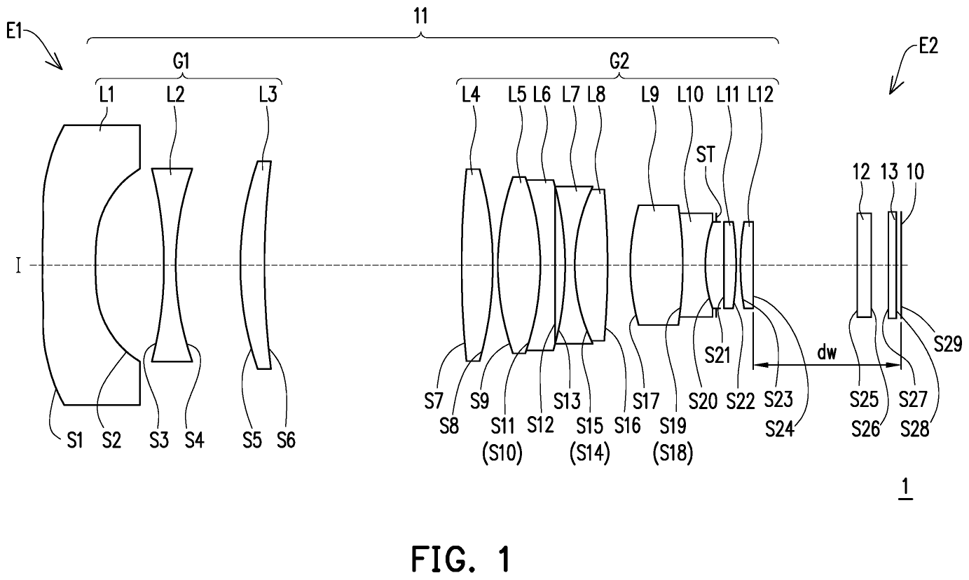

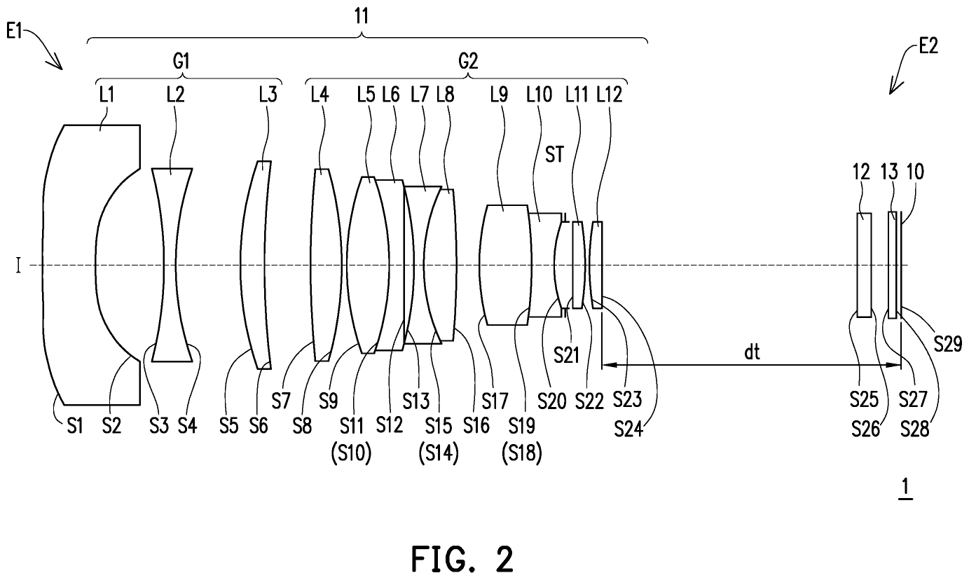

FIG. 1 and FIG. 2 are schematic diagrams respectively showing a projector 1 at the wide-end and the tele-end according to an embodiment of the invention. The wide-end and the tele-end respectively refer to states where the focal length of a projection zoom lens is adjusted to the longest and the shortest.

Referring to FIG. 1, the projector 1 includes an image source 10 and a projection zoom lens 11. The image source 10 provides an image beam (not shown). For example, the image source 10 may be a digital micro-mirror device (DMD), a liquid-crystal-on-silicon panel (LCOS panel), or other suitable spatial light modulators (SLM), but not limited thereto. The projection zoom lens 11 is disposed on the transmission path of the image beam generated from the image source 10 to project the image beam onto a screen (not shown) so as to form a projection image.

The screen may be a whiteboard, a curtain, a wall, or other objects for forming an image.

The projection zoom lens 11 includes a first lens group G1 and a second lens group G2 which are sequentially arranged along an optical axis I from a screen end E1 to an image source end E2. The screen is located at the screen end E1. The image source 10 is located at the image source end E2. In other words, the image beam from the image source 10 is projected onto the object (for example, the screen) for forming an image sequentially via the second lens group G2 and the first lens group G1.

The first lens group G1 has a negative refractive power while the second lens group G2 has a positive refractive power. The refractive power of the first lens group G1 is negative, which contributes to improving the light collecting effect and facilitating the optical path design and lens production. The refractive power of the second lens group G2 is positive, which contributes to improving the light converging effect and the resolution of the projection image.

The first lens group G1 includes a first lens L1, a second lens L2, and a third lens L3. The second lens group G2 includes a fourth lens L4, a fifth lens L5, a sixth lens L6, a seventh lens L7, an eighth lens L8, a ninth lens L9, a tenth lens L10, an eleventh lens L11, and a twelfth lens L12. The first lens L1 to the twelfth lens L12 and the image source 10 are sequentially arranged along the optical axis I from the screen end E1 to the image source end E2, and the refractive powers of the first lens L1 to the twelfth lens L12 are negative, negative, positive, positive, positive, negative, negative, positive, positive, negative, positive, and positive.

For example, the second lens L2 may be a biconcave lens. The third lens L3 may be a concavo-convex lens with the convex surface (for example, the surface S5) facing to the screen end E1. The fourth lens L4 may be a biconvex lens. The fifth lens L5 may be a biconvex lens. The sixth lens L6 may be a biconcave lens. The seventh lens L7 may be a biconcave lens. The eighth lens L8 may be a biconvex lens. The ninth lens L9 may be a biconvex lens. The tenth lens L10 may be a biconcave lens. The eleventh lens L11 may be a biconvex lens. The twelfth lens L12 may be a plano-convex lens with the convex surface (for example, the surface S23) facing to the screen end E1. However, the surface shape of each lens is not limited thereto and may be changed as required.

In the present embodiment, the projection zoom lens 11 has twelve lenses, and the total number of the lenses in the projection zoom lens 11 is, for example, twelve, wherein the first lens L1 is the lens closest to the screen end E1 among the twelve lenses, and the twelfth lens L12 is the lens closest to the image source end E2 among the twelve lenses. The first lens L1 may be a plastic aspherical lens, which not only helps to correct aberrations (such as spherical aberration, coma aberration, astigmatic field curvature, and distortion) but also helps to reduce the diameter of the first lens L1, thereby reducing the weight, size, and production cost of the projection zoom lens 11. In addition, the second lens L2 to the twelfth lens L12 may all be spherical lenses such as spherical lenses made of glass or plastic to reduce the production cost of the projection zoom lens 11. In the embodiment, the second lens L2 to the twelfth lens L12 may all be spherical lenses made of glass.

The second lens group G2 may include three sets of cemented doublet lenses, and the refractive powers of the three sets of cemented doublet lenses are positive, positive, and negative from the screen end E1 to the image source end E2. For example, the fifth lens L5 and the sixth lens L6 may form the first set of cemented doublet lenses. The seventh lens L7 and the eighth lens L8 may form the second set of cemented doublet lenses. The ninth lens L9 and the tenth lens L10 may form the third set of cemented doublet lenses. The design of the three sets of cemented doublet lenses not only helps to correct the aberrations but also helps to reduce the total length of the second lens group G2, thereby further reducing the size of the projection zoom lens 11.

In the projection zoom lens 11, the distance between any two adjacent lenses in any one of the first lens group G1 and the second lens group G2 is a fixed value. That is, the distance between any two adjacent lenses in any one of the first lens group G1 and the second lens group G2 does not change with the change in the focal length of the projection zoom lens 11. Specifically, in the first lens group G1, the distance between the first lens L1 and the second lens L2 is fixed, and the distance between the second lens L2 and the third lens L3 is fixed. Further, in the second lens group G2, the distance between the fourth lens L4 and the fifth lens L5 is fixed, the distance between the fifth lens L5 and the sixth lens L6 is fixed, the distance between the sixth lens L6 and the seventh lens L7 is fixed, the distance between the seventh lens L7 and the eighth lens L8 is fixed, the distance between the eighth lens L8 and the ninth lens L9 is fixed, the distance between the ninth lens L9 and the tenth lens L10 is fixed, the distance between the tenth lens L10 and the eleventh lens L11 is fixed, and the distance between the eleventh lens L11 and the twelfth lens L12 is fixed. The distance described above refers to the linear distance between the centers of two adjacent lenses on the optical axis I.

On the other hand, the distance between the first lens group G1 and the object (for example, the screen) for forming an image, the distance between the first lens group G1 and the second lens group G2, and the distance between the second lens group G2 and the image source 10 are changeable. Specifically, the first lens group G1 is configured to move along the optical axis I between the screen end E1 and the image source end E2 so as to focus the projection zoom lens 11. Further, the second lens group G2 is configured to move along the optical axis I between the screen end E1 and the image source end E2 so as to adjust the size of the projection image.

In addition, the projection zoom lens 11 satisfies: 1.2<|dt/dw|<2.5, wherein dt is the distance between the second lens group G2 and the image source 10 when the projection zoom lens 11 is at the tele-end, and dw is the distance between the second lens group G2 and the image source 10 when the projection zoom lens 11 is at the wide-end. With the design described above, the size and sharpness of the projection image can be effectively controlled.

The projection zoom lens 11 may further include other components to meet different requirements. For example, the projection zoom lens 11 may include a stop ST. The stop ST is disposed, for example, between the tenth lens L10 and the eleventh lens L11 to facilitate the design of the exit pupil and achieve the desired zoom capability.

The projection zoom lens 11 may also include a flat glass actuator 12. The flat glass actuator 12 may be disposed between the second lens group G2 and the image source 10. The flat glass actuator 12 oscillates back and forth around a rotation axis (not shown) at a fixed position on the optical axis I, and the rotation axis is, for example, perpendicular to the optical axis I, which helps to improve the resolution of the projection image.

The projection zoom lens 11 may further include a glass cover 13. The glass cover 13 may be disposed between the flat glass actuator 12 and the image source 10 and cover the image source 10 so as to protect the image source 10 and prevent dust from attaching to the image source 10.

Tables 1 to 3 list data of an exemplary embodiment of the projection zoom lens 11. However, the data set forth below is not intended to limit the invention. After referring to the disclosure of the invention, any person skilled in the art may make appropriate changes to the parameters or settings, which still fall within the scope of the invention.

In Table 1, “distance” refers to the distance between adjacent two surfaces on the optical axis I. For example, the distance corresponding to the surface S1 of the first lens L1 refers to the distance between the surface S1 and the surface S2 of the first lens L1 on the optical axis I. In addition, since the fifth lens L5 and the sixth lens L6 are a set (first set) of cemented doublet lenses, the surface S10 of the fifth lens L5 and the surface S11 of the sixth lens L6 have the same curvature radius, and the distance between the surface S10 and the surface S11 on the optical axis I is 0. Therefore, the surface S10 of the fifth lens L5 is omitted from Table 1. Similarly, the seventh lens L7 and the eighth lens L8 are a set (second set) of cemented doublet lenses, and the ninth lens L9 and the tenth lens L10 are a set (third set) of cemented doublet lenses. Therefore, the surface S14 of the seventh lens L7 and the surface S18 of the ninth lens L9 are omitted from Table 1.

TABLE 1

| | | Curvature | | | |
|---|---|---|---|---|---|
| | Sur- | radius | Distance | Refractive | Abbe |
| Element | face | (mm) | (mm) | index | number |
| First lens L1 | S1 | −174.8 | 8.4 | 1.52 | 56 |
| | S2 | 35.4 | 11.0 | | |
| Second lens L2 | S3 | −67.9 | 1.8 | 1.56 | 60 |
| | S4 | 45.6 | 10.8 | | |
| Third lens L3 | S5 | 53.6 | 3.8 | 1.79 | 25 |
| | S6 | 136.0 | D1 | | |
| | | | (changeable) | | |
| Fourth lens L4 | S7 | 133.7 | 5.1 | 1.61 | 63 |
| | S8 | −56.3 | 0.6 | | |
| Fifth lens L5 | S9 | 41.5 | 7.1 | 1.60 | 60 |
| Sixth lens L6 | S11 | −41.5 | 1.6 | 1.79 | 25 |
| | S12 | 234.1 | 2.3 | | |
| Seventh lens L7 | S13 | −46.9 | 1.6 | 1.58 | 40 |
| Eighth lens L8 | S15 | 28.4 | 5.3 | 1.79 | 25 |
| | S16 | −144.3 | 3.7 | | |
| Ninth lens L9 | S17 | 34.6 | 8.6 | 1.61 | 63 |
| Tenth lens L10 | S19 | −63.2 | 3.6 | 1.76 | 26 |
| | S20 | 20.8 | 1.7 | | |
| Stop ST | | Infinite | 1.3 | | |
| Eleventh lens L11 | S21 | 171.5 | 2.1 | 1.65 | 50 |
| | S22 | −49.8 | 0.6 | | |
| Twelfth lens L12 | S23 | 36.7 | 2.2 | 1.61 | 63 |
| | S24 | −488.1 | D2 | | |
| | | | (changeable) | | |
| Flat glass | S25 | Infinite | 2.0 | 1.52 | 58 |
| actuator 12 | S26 | Infinite | 3.0 | | |
| Glass cover 13 | S27 | Infinite | 1.1 | 1.51 | 61 |
| | S28 | Infinite | 0.7 | | |
| Image source 10 | S29 | Infinite | 0.0 | | |

In Table 1, the surfaces S1 and S2 of the first lens L1 are aspherical, and the surfaces (the surfaces S3 to S24) of the remaining lenses are spherical. The aspherical formula is as follows:

$$X = \frac{{Y}^{2}}{R ( 1 + \sqrt{1 - ( 1 + k ) \times {Y}^{2} / {R}^{2}} )} + {A}_{4} {Y}^{4} + {A}_{6} {Y}^{6} + {A}_{8} {Y}^{8} + {A}_{10} {Y}^{10} + {A}_{12} {Y}^{12} + {A}_{14} {Y}^{14} + {A}_{16} {Y}^{16}$$

In the above formula, X is the sag in the optical axis direction. R is the radius of the osculating sphere, that is, the curvature radius near the optical axis (such as the curvature radius listed in Table 1). k is the conic. Y is the aspherical height, that is, the height from the lens center toward the lens edge, and the coefficients A₄, A₆, A₈, A₁₀, A₁₂, A₁₄, and A₁₆ are aspheric coefficients. Table 2 lists the parameters of the surfaces S1 and S2 of the first lens L1.

TABLE 2

| | S1 | S2 |
|---|---|---|
| k | 2.074 | 3.044 |
| A₄ | 3.87E−05 | 4.55E−05 |
| A₆ | −1.09E−07 | −7.92E−08 |
| A₈ | 3.25E−10 | −9.32E−11 |
| A₁₀ | −7.51E−13 | 3.86E−12 |
| A₁₂ | 1.18E−15 | −2.60E−14 |
| A₁₄ | −1.09E−18 | 8.23E−17 |
| A₁₆ | 4.42E−22 | −1.08E−19 |

Table 3 lists examples of the changeable distances in Table 1 at the wide-end and the tele-end. In Table 3, the unit of each numerical value is millimeter (mm).

TABLE 3

| | Wide-end | Tele-end |
|---|---|---|
| Distance D1 | 32 | 5.8 |
| Distance D2 | 17 | 24.6 |

In the embodiment, the projection zoom lens 11 is a non-telecentric system, and the f-number of the projection zoom lens 11 may be less than 1.9. Compared with the conventional projection zoom lenses, the projection zoom lens 11 of the embodiment has a larger aperture (high light output efficiency).

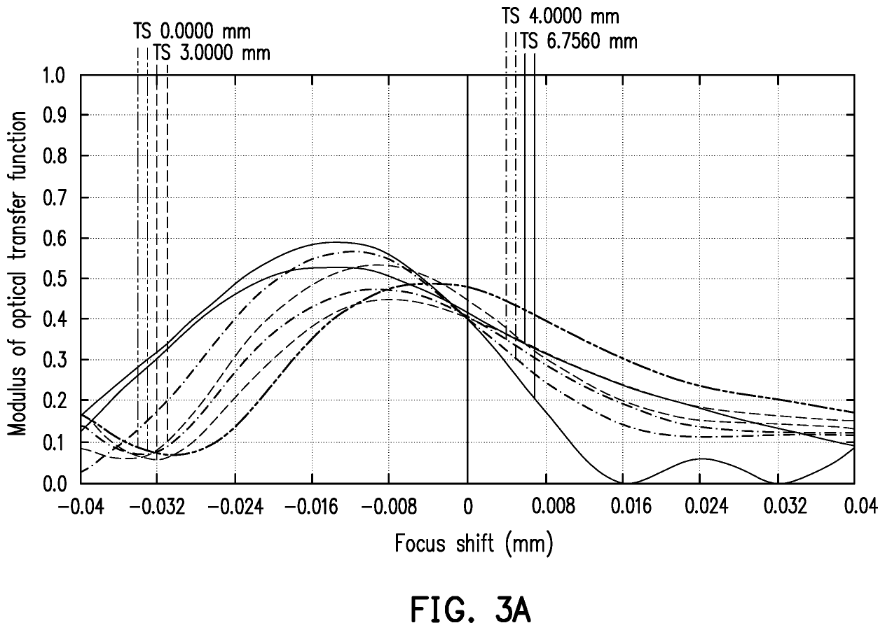

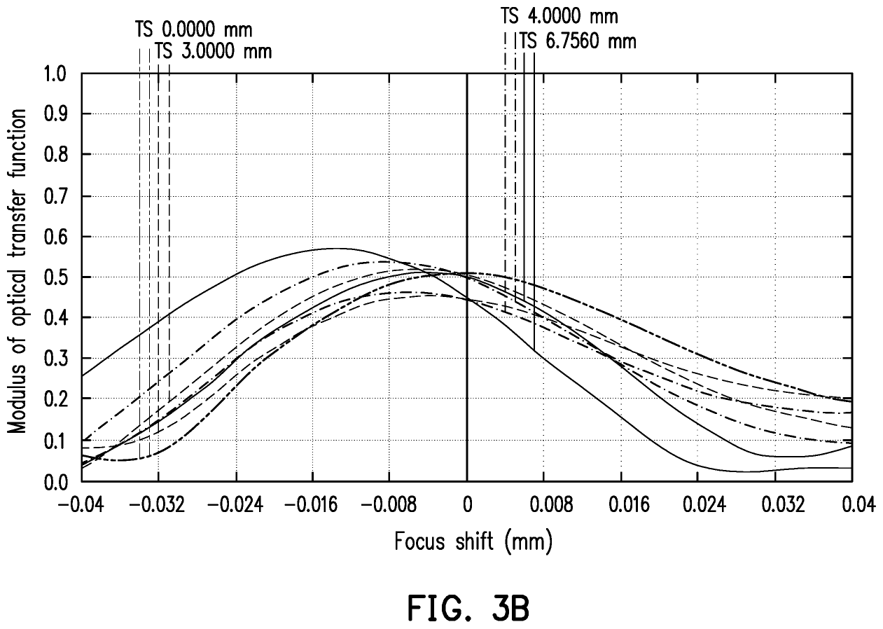

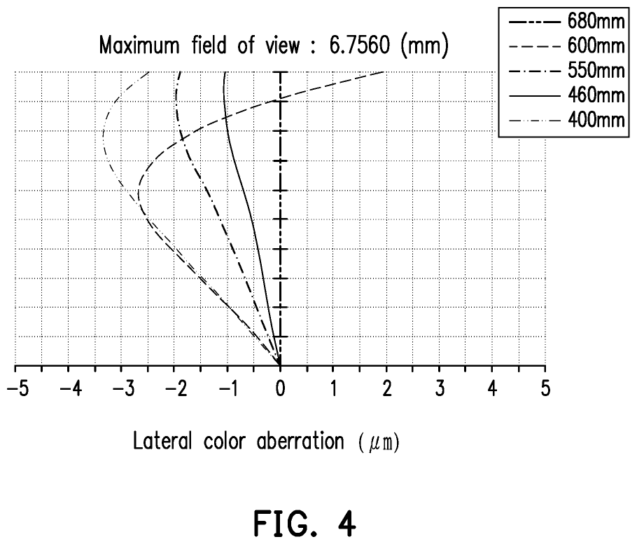

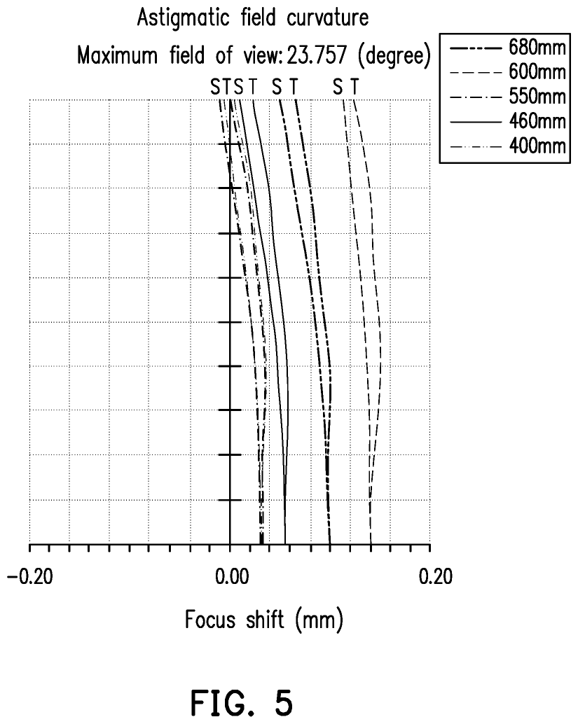

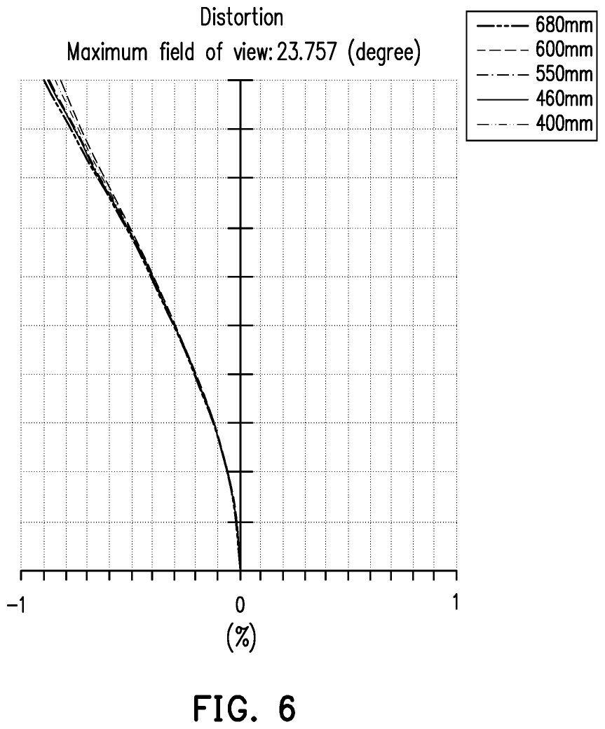

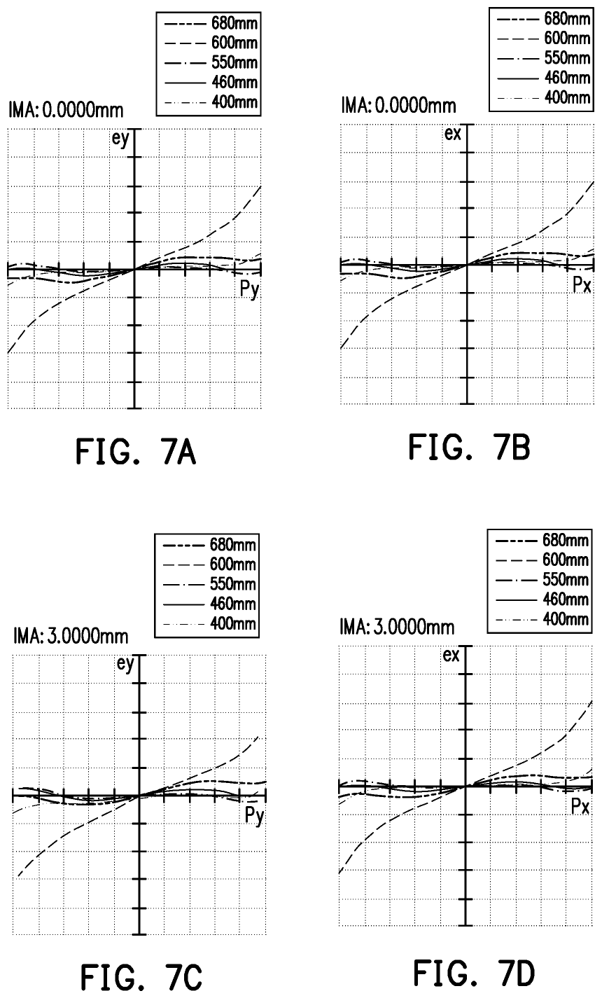

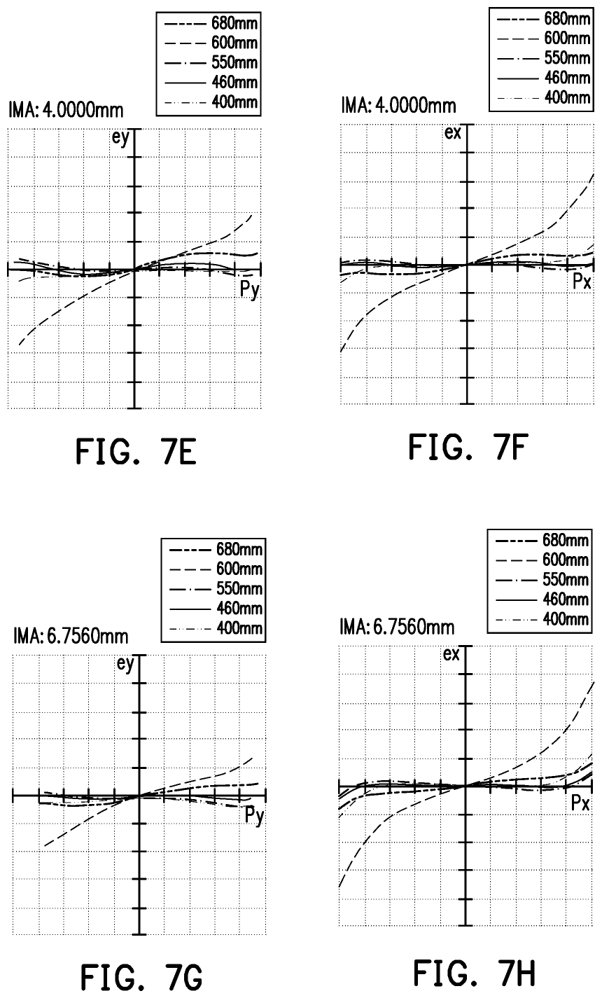

FIG. 3A and FIG. 3B are modulation transfer function (MTF) graphs of a projector at the wide-end and the tele-end according to an embodiment of the invention. FIG. 4 to FIG. 6 are a lateral color aberration graph, an astigmatic field curvature graph, and a distortion graph of the projector according to an embodiment of the invention. FIG. 7A to FIG. 7H are ray fan plots of the projector according to an embodiment of the invention. In FIG. 3A to FIG. 7H, the simulations are all performed at wavelengths of 400 nm, 460 nm, 550 nm, 600 nm, and 680 nm. In FIG. 3A and FIG. 3B, the spatial frequency is 93.0000 cycles/mm, wherein TS 0.0000 mm is the optical transfer function curve of the object height of the image source on the optical axis, TS 3.0000 mm is the optical transfer function curve of 0.375 times the object height of the image source, TS 4.0000 mm is the optical transfer function curve of 0.5 times the object height of the image source, and TS 6.756 mm is the optical transfer function curve of 0.8 times the object height of the image source. In FIG. 5, the curves T respectively represent astigmatic field curvatures of lights of different wavelengths in the tangential direction, and the curves S respectively represent astigmatic field curvatures of lights of different wavelengths in the sagittal direction. In FIG. 7A to FIG. 7H, the maximum scale and the minimum scale of the ey axis and the ex axis are ±70 μm, and the maximum scale and the minimum scale of the Py axis and the Px axis are ±1 μm. The patterns shown in FIG. 3A to FIG. 7H are all within the standard range, which show that the projector 1 of the present embodiment renders good image quality.

In summary, the embodiments of the invention have at least one of the following advantages or effects. According to the embodiments of the projection zoom lens and the projector of the invention, the projection zoom lens uses twelve lenses to form two lens groups and realizes the zoom function by adjusting the relative positions of the two lens groups. Therefore, the projection zoom lens and the projector of the invention achieve a balance between optical imaging quality, cost, and assembly difficulty.

In addition, the first lens may be a plastic aspherical lens so as to reduce the production cost and maintain the optical imaging quality. Moreover, disposing the stop between the tenth lens and the eleventh lens facilitates the design of the exit pupil and achieves the desired zoom capability. The refractive power of the first lens group is negative, which contributes to improving the light collecting effect and facilitating the design and production. The refractive power of the second lens group is positive, which realizes better light concentrating capability and helps to improve the resolution of the projection image. Since the second lens to the twelfth lens are all spherical lenses, the overall production cost of the projection zoom lens is reduced. Disposing three sets of cemented doublet lenses not only helps to correct aberrations but also reduces the total length of the second lens group, thereby further reducing the size of the projection zoom lens. In an embodiment, the ratio of the distance dt (the distance between the second lens group and the image source when the projection zoom lens is at the tele-end) to the distance dw (the distance between the second lens group and the image source when the projection zoom lens is at the wide-end) may also be adjusted to effectively control the size and sharpness of the projection image. In an embodiment, the resolution of the projection image may be improved by disposing the flat glass actuator. In an embodiment, the glass cover may be disposed to protect the image source and prevent dust from attaching to the image source.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection zoom lens, comprising a first lens group and a second lens group which are sequentially arranged along an optical axis from a screen end to an image source end,
wherein the first lens group has a negative refractive power and comprises a first lens, a second lens, and a third lens; and the second lens group has a positive refractive power and comprises a fourth lens, a fifth lens, a sixth lens, a seventh lens, an eighth lens, a ninth lens, a tenth lens, an eleventh lens, and a twelfth lens, wherein the first lens to the twelfth lens are sequentially arranged along the optical axis from the screen end to the image source end, and refractive powers of the first lens to the twelfth lens are negative, negative, positive, positive, positive, negative, negative, positive, positive, negative, positive, and positive.

2. The projection zoom lens according to claim 1, wherein the first lens group is configured to move along the optical axis between the screen end and the image source end to focus the projection zoom lens, and the second lens group is configured to move along the optical axis between the screen end and the image source end to adjust a size of a projection image.

3. The projection zoom lens according to claim 1, wherein the projection zoom lens satisfies:
1.2<|dt/dw|<2.5,
wherein dt is a distance between the second lens group and an image source when the projection zoom lens is at a tele-end, and dw is a distance between the second lens group and the image source when the projection zoom lens is at a wide-end.

4. The projection zoom lens according to claim 1, further comprising:
a stop disposed between the tenth lens and the eleventh lens.

5. The projection zoom lens according to claim 1, wherein the second lens group comprises three sets of cemented doublet lenses, and refractive powers of the three sets of cemented doublet lenses are positive, positive, and negative sequentially from the screen end to the image source end.

6. The projection zoom lens according to claim 1, wherein the first lens is a plastic aspherical lens.

7. The projection zoom lens according to claim 1, wherein the second lens is a biconcave lens, the third lens is a concavo-convex lens with a convex surface facing to the screen end, the fourth lens is a biconvex lens, the fifth lens is a biconvex lens, the sixth lens is a biconcave lens, the seventh lens is a biconcave lens, the eighth lens is a biconvex lens, the ninth lens is a biconvex lens, the tenth lens is a biconcave lens, the eleventh lens is a biconvex lens, and the twelfth lens is a plano-convex lens with a convex surface facing to the screen end.

8. The projection zoom lens according to claim 1, wherein the projection zoom lens is a non-telecentric system.

9. The projection zoom lens according to claim 1, further comprising:
a flat glass actuator, wherein the second lens group is disposed between the first lens group and the flat glass actuator.

10. The projection zoom lens according to claim 1, wherein the projection zoom lens has a f-number less than 1.9.

11. A projector, comprising an image source and a projection zoom lens,
wherein the image source provides an image beam; and
the projection zoom lens is disposed on a transmission path of the image beam to project the image beam onto a screen to form a projection image,
wherein the projection zoom lens comprises a first lens group and a second lens group which are sequentially arranged along an optical axis from a screen end to an image source end, the screen is located at the screen end, and the image source is located at the image source end,
wherein the first lens group has a negative refractive power and comprises a first lens, a second lens, and a third lens; and the second lens group has a positive refractive power and comprises a fourth lens, a fifth lens, a sixth lens, a seventh lens, an eighth lens, a ninth lens, a tenth lens, an eleventh lens, and a twelfth lens, wherein the first lens to the twelfth lens and the image source are sequentially arranged along the optical axis from the screen end to the image source end, and refractive powers of the first lens to the twelfth lens are negative, negative, positive, positive, positive, negative, negative, positive, positive, negative, positive, and positive.

12. The projector according to claim 11, wherein the first lens group is configured to move along the optical axis between the screen end and the image source end to focus the projection zoom lens, and the second lens group is configured to move along the optical axis between the screen end and the image source end to adjust a size of the projection image.

13. The projector according to claim 11, wherein the projection zoom lens satisfies:
1.2<|dt/dw|<2.5,
wherein dt is a distance between the second lens group and the image source when the projection zoom lens is at a tele-end, and dw is a distance between the second lens group and the image source when the projection zoom lens is at a wide-end.

14. The projector according to claim 11, wherein the projection zoom lens further comprises:
a stop disposed between the tenth lens and the eleventh lens.

15. The projector according to claim 11, wherein the second lens group comprises three sets of cemented doublet lenses, and refractive powers of the three sets of cemented doublet lenses are positive, positive, and negative sequentially from the screen end to the image source end.

16. The projector according to claim 11, wherein the first lens is a plastic aspherical lens.

17. The projector according to claim 11, wherein the second lens is a biconcave lens, the third lens is a concavo-convex lens with a convex surface facing to the screen end, the fourth lens is a biconvex lens, the fifth lens is a biconvex lens, the sixth lens is a biconcave lens, the seventh lens is a biconcave lens, the eighth lens is a biconvex lens, the ninth lens is a biconvex lens, the tenth lens is a biconcave lens, the eleventh lens is a biconvex lens, and the twelfth lens is a plano-convex lens with a convex surface facing to the screen end.

18. The projector according to claim 11, wherein the projection zoom lens is a non-telecentric system.

19. The projector according to claim 11, wherein the projection zoom lens further comprises:
a flat glass actuator disposed between the second lens group and the image source.

20. The projector according to claim 11, wherein the projection zoom lens has a f-number less than 1.9.
